(19) United States
(12) Patent Application Publication
(10) Pub. No.: US 2014/0125779 A1
(43) Pub. Date: May 8, 2014

(54) CAPTURING AND VISUALIZATION OF IMAGES AND VIDEO FOR AUTOSTEREOSCOPIC DISPLAY

(71) Applicants: Lars Thomas Kristian Ericson, Bromma (SE); Christian Nicolai Moller, Oslo (NO)

(72) Inventors: Lars Thomas Kristian Ericson, Bromma (SE); Christian Nicolai Moller, Oslo (NO)

(21) Appl. No.: 13/988,064

(22) PCT Filed: Nov. 18, 2011
(86) PCT No.: PCT/EP2011/070502

§ 371 Date: Dec. 30, 2013

(30) Foreign Application Priority Data
Nov. 19, 2010 (GB) 1019694.7

(51) Int. Cl. H04N 13/04

(52) U.S. Cl. CPC H04N 13/0402
USPC 348/51

(57) ABSTRACT

An autostereoscopic display apparatus or a light field display apparatus arranged to provide different display properties to different viewer positions (e.g. colour bit depth; brightness; contrast ratio; spatial resolution; image depth quality; perspective density; refresh rate; flicker rate; and gamma curve). There is also provided a method for presenting three dimensional information on an autostereoscopic or lightfield display comprising showing at least two different representations of the three dimensional information to at least two different viewer positions. There is also provided a method for capturing and visualising a real three dimensional object or scene comprising using at least two different image capturing methods to capture the real three dimensional object or scene, visualising the captured information on an autostereoscopic or lightfield display, using data points from each image capturing methods to verify and adjust the correct relative positions and transformations of the images captured using the different capturing methods.

The present invention relates to capturing and visualising images and video for an autostereoscopic display apparatus.

### BACKGROUND

A well proven method for creating a 3D image is to cause a viewer to see different perspective views of a scene with each eye. One way to do this is to display two differently polarized images on a screen, and for the viewer to wear corresponding polarizing filters on each eye.

An autostereoscopic display or a three dimensional (3D) display may be implemented using an aperture or slit array in conjunction with a two dimensional (2D) display to display a 3D image. The principle of the device is that when looking at a 2D image through a slit array, the slit array separated from the screen by a distance, then the viewer sees a different part of the 2D image with each eye. If an appropriate image is rendered and displayed on the 2D display, then a different perspective image can be displayed to each eye of the viewer without necessitating them to wear filters over each eye.

Autostereoscopic displays provide additional challenges and opportunities with regards to the image acquisition and presentation. The present invention addresses some of these.

### DESCRIPTION

Embodiments of the invention are directed towards capturing images for an autostereoscopic display and visualising the images along with other 3D data on an autostereoscopic display. The invention disclosed herein may be implemented in the scanning slit time-multiplexed system described in PCT application PCT/IB2005/001480. However, the invention may also be used in conjunction with other display systems. For example, a similar system where the scanning slit in a shutter in front of the display is replaced with a device that creates a slit shaped scanning backlight to give the same effect may be used. In this case the scanning backlight may be treated as the shutter. The aperture in the shutter and the shape of the backlight may have a shape other than a slit. Other types of autostereoscopic displays and displays referred to as lightfield displays may also be used. There is a wide range of application areas, while medical imaging will be used as an example.

Autostereoscopic and lightfield displays that allow viewers to move freely are typically multi-perspective displays, i.e. they provide at least two but in many instances many more perspectives. Methods for capturing multiple and even continuous perspectives directly exist in the form of so called light field sensors. These may for example use a lenticular array between the scene being recorded and the imaging sensor. While these methods are not covered in detail in this document they may be used in combination with methods presented herein.

Other methods for capturing and presenting multiple perspectives include calculating, for example through interpolation, perspectives from cameras that capture one or several perspective views, but fewer views than the display can show. Many techniques for this exist mainly based on using a depth or disparity map along with original images. Depth map can be obtained through processing the images themselves or by additional sensors that obtain the depth map directly from the scene being recorded.

In one embodiment, an autostereoscopic display apparatus or a light field display apparatus is arranged to provide different display properties to different viewer positions. Examples of such display properties may be such as, but not limited to: colour bit depth; brightness; contrast ratio; spatial resolution; image depth quality; perspective density; refresh rate; flicker rate; and gamma curve. The display properties for a viewing position can be changed during operation of the display. The display properties for different viewer positions may be set to match the image content being shown to the viewer position in question.

In a further embodiment, at least two different representations of the three dimensional information may be shown to at least two different viewer positions. The different representations of the three dimensional information may be the result of different recording methods for the same three dimensional information (e.g. pressure and temperature measurements of a three dimensional space; different statistical samples of the same population etc) and/or different image capture methods (such as but not limited to: computed tomography; magnetic resonance imaging; ultrasound; optical camera; depth camera; laser surface scanning; positron emission tomography; and x-ray).

Some (for instance at least two) of the representations may be the result of different processing of the same original representation (e.g. different transfer functions for a CT or different image filtering of a camera image). The representations may provide perspectives that are matched to the viewer position where the representation is shown. The matching may give the effect that when the viewer moves and experiences parallax the scene appears to be stationary while the representation of the scene changes.

The three dimensional information typically relates to a real three dimensional object or scene.

In a further embodiment, an autostereoscopic display apparatus or a light field display apparatus is arranged to provide a first set of images to a first viewing position and a second set of images to a second viewing position, the second set of images being derived from the first set of images. The images captured directly from a camera may have higher image quality or less latency than images derived from those directly captured images. In some situations it may be advantageous to present both types of images to the viewer. One way to achieve this is to provide at least one view zone where at least one directly captured image is shown and to show derived images for other view positions. The images may be derived by interpolation or using other known techniques.

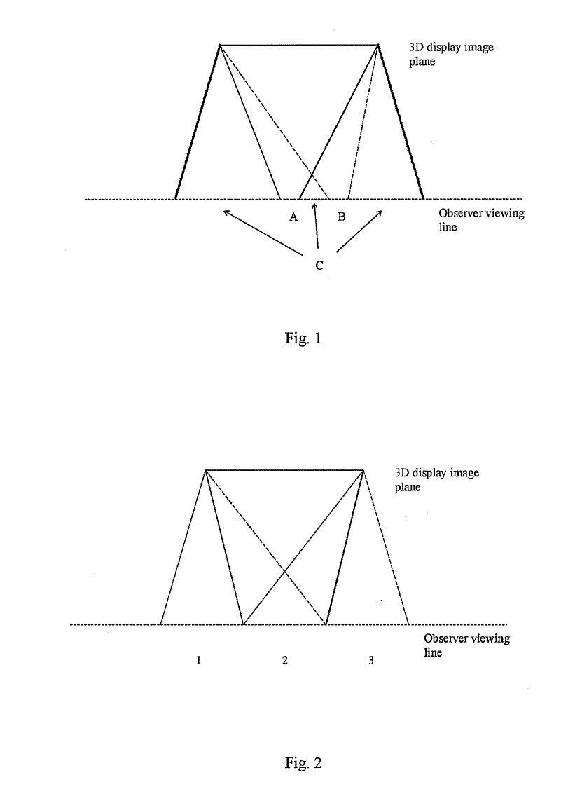

FIG. 1 shows an example where two cameras have been used to provide two directly captured images. In zone A of the view line images from camera A are shown, in zone B images from camera B are shown, and in the other zones C derived images are shown. The zones A and B may be positioned such that the position of the centre of each zone have the same separation in relation to the distance to the conversion plane and/or the focus plane of the 3D display as the cameras to the plane of focus in the scene being captured. Derived images may be provided with the same or different angular perspective separation as the directly captured images. In many instances the 3D quality is improved by smaller perspective separation and derived images may be provided with the minimum perspective separation that the 3D display can reproduce.

In some applications it may be beneficial to track the position of the viewers head as to shift the zones with the directly captures image to be located at the viewers head or eye positions. One may also provide a head rest located such that it ensures that one or several viewer's eyes are seeing directly captured images. The head rest may be tracked such that the zones can be shifted when the head rest is moved.

In order to give minimum latency for directly captured images these could be given a separate image channel from the camera to the display imaging device. The directly captured images may then also be sent in a separate channel to the image processing device that calculates the derived images and then via a channel to the display imaging device.

Another method is to have a user switch to switch between a first mode where only directly captured images in zones corresponding to camera positions are shown and a second mode where all zones show only derived images.

In some instances there will be more than one type of image data that represent different aspects of the same scene. This can be directly captured images based on different types of cameras, e.g. a standard camera and an IR camera. It may also be data from other imaging sources such as CT, MRI and ultrasound. The 3D display and the capturing system may provide several ways of effectively representing the different types of data. The methods described can be used stand alone or as a combination of the different methods.

FIG. 2 shows an intuitive switch between viewing different data and different filtering of data by showing them in different view zones. An autostereoscopic display is effectively a directional display that can show different images to different directions in one or more viewer zones. The example shows zone 1 where direct or derived camera perspectives 1-50 are shown, zone 2 shows equivalent perspectives 51-100 based on computed tomography data of the same scene, and zone 3 IR camera perspectives 101-150. The zones do not need to be distinct as shown in this example. One could instead do a gradual transition from one type of data or filtering to another. For example, two transfer functions for a CT dataset could be interpolated between perspective 1 and 150 such that each perspective presented to the user has a unique transfer function. Another example would be to show directly captured camera images in zones A and B in FIG. 1, and corresponding perspectives of rendered CT images in zones C. One may also show no information in zones C in order to avoid inverted images in repeated zones that some autostereoscopic and lightfield displays have.

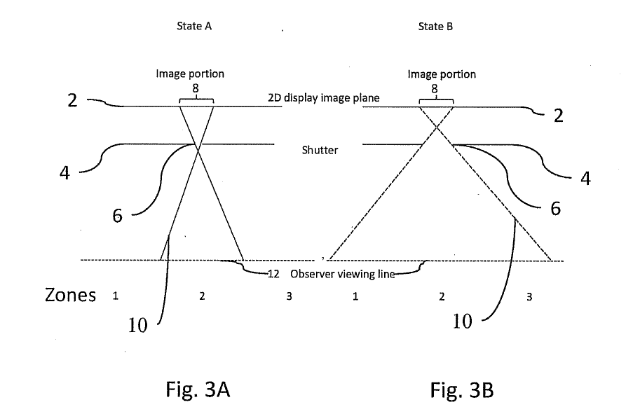

The optimal display properties may be different for different types of data. For example, camera images may require higher colour bit depth than images rendered from a CT dataset. The display may thus be set to provide different properties for different viewing zones, view direction etc. Properties that could change include, but are not limited to, colour bit depth, gamma curve, brightness, refresh rate, contrast ration, perspective density and display resolution. Perspective density is defined as the number of different perspectives that the display can provide for a given angular viewing range. An example looking at a single 3D pixel would be the number of different colours the 3D pixel can provide over a 10 degree viewing angle. The resulting visual effect of different perspective densities is typically different depth quality in the reproduction of a scene. One way to achieve a higher colour bit depth for a central viewing zone, e.g. zone 2 in FIG. 2, than for other viewing zones, e.g. zones 1 and 3 in FIG. 2 will be explained with reference to a scanning slit time multiplexed system using a time multiplexed 2D display to provide levels of colour and greyscale. One may operate the shutter such that the viewing cone when showing the least significant bit on the 2D display is equivalent to zone 1, while the viewing cone for all other bits is the full width of zones 1, 2 and 3 together. This is illustrated in FIGS. 3A and 3B. In state A as shown in FIG. 3A only the least significant bit is shown on the 2D display 2 and the shutter 4 has a narrow slit 6 open such that the image portion 8 on the 2D display 2 will only be seen in zone 2 on the observer viewing line 12. In state B, as shown in FIG. 3B, all other bits are shown on the 2D display 2 and the shutter has 4 a wider slit 6 open such that the image portion 8 is seen in all of zones 1, 2 and 3. The viewing cone 10 may be defined as the range of viewing angles where the viewer sees a part of the 2D display 2 through a given open slit 6 where this part of the 2D display 2 belongs to the image on the 2D display 2 associated with the same open slit 6, illustrated as the image portion 8 in FIG. 3.

A number of methods could be used to ensure that camera images and data from other imaging sources or other cameras are accurately aligned. One way is to have known and pre-calibrated information on the relative position and angles between the image capture devices, in addition to information on how each image capture device's position relates to the position of the image data that it captures. For example an MR scanner may provide information on where a captured voxel is positioned relative to the scanner itself, and a microscope that is attached rigidly to the MR may provide information on the position of its focus point. By knowing the relative position of the MR scanner and the microscope, the relative position of a voxel and the focus point of the microscope may be determined. A more flexible approach involves continuously tracking the relative position of the image capture devices. In medical procedures it is common to use navigation systems to track both the patient and the camera and to co-register these with other imaging data such as CT, MRI or ultrasound. Tracking can be done is several ways with common methods being through depth cameras, comprising two or more normal or IR cameras or through using electromagnetic tracking. Another method is to use cameras using time of flight technology to obtain the depth for each pixel in an image. Light field cameras that can capture information on the properties of incoming light from different directions in a given point may also be used to obtain depth information about a scene and objects within it.

When capturing a static scene, a nearly static scene or a scene where the relevant objects are static one may collect more extensive information about the scene by combining information from two or more instances in time. This is for example used when creating a 3D volume using a 2D ultrasound probe. The 2D ultrasound probe captures a 2D plane of information from an object, e.g. a patient. The probe is then moved and the movement is tracked by one of the tracking methods mentioned above. This captures information on the volume swept when the 2D plane moves through the relevant parts of the object. Similarly a camera providing a depth image of a scene, i.e. information on both colour and depth for one or several points in the scene, may be tracked such that a composite image or 3D model can be created both by moving the depth camera sideways and by capturing the depth images from different angles of the scene or object. One may also do an overlay such that one type of 3D data such as CT, MRI images can be shown at the same time for one or several view directions as another type of data such as the camera data that may come from a microscope or camera. One way to achieve this is to use a navigation system that tracks the camera and the scene being captured, such as the patient. A standard process is then used to co-register the patient position with the CT, MRI or other imaging data of the patient. By using the depth map derived from any of the methods mentioned above it is possible to know the position of a pixel in the camera image in the co-ordinate system of the tracing system and hence to render it in the correct position and show it simultaneously as for example the CT data.

One problem facing surgeons using navigation systems is that the brain shifts during surgery compared to its position when the image data from CT, MRI, ultrasound etc were taken. The example below will make reference to a CT and a camera, but the same method may be applied to any combination of image capture devices. One way to overcome this problem is to transform the image data based on direct observations during surgery. A simple transformation would be to shift, rotate or scale all points in the CT volume. This may not be correct since the shift depends on the type of substance or tissue as well as the position in the brain. By modelling those parameters it is possible to more accurately calculate a transformation on how structures and substances in the brain will shift. Accuracy may also be improved by matching internal anatomical landmarks in the brain as seen directly or through the use of a camera or microscope with the same landmarks in the CT. This may be achieved by selecting a pixel on a landmark in the camera image, since the tracking described above can give the position of a pixel in the tracked co-ordinate system, and matching the selected point with the same point on the landmark based on the CT image. Another method may include using automatic or semi-automatic image co-registration methods. There are a number of available algorithms available for such co-registration based on the image information in two or more 3D volumes, and such methods are for example used for co-registration of CT and MR images of the same patient. The methods may both be based on rigid body assumptions and provide only translation, rotation and scaling of a 3D volume or scene. They may also allow for non-rigid transformations where additional relative transformations within the same 3D volume or scene are allowed. The co-registration may be followed by a visual confirmation step by the viewer and may include the possibility to make manual adjustments. One may also use other methods such as using a pointing tool that is tracked and point it to the landmark. Combining the methods described in this paragraph may improve accuracy further.

In a further embodiment, at least two different image capturing methods may be used to capture a three dimensional object or scene. The captured information is visualised on an autostereoscopic or lightfield display. Data points from each image capturing method are then used to verify and adjust the correct relative positions and transformations of the images captured using the different capturing methods.

The relative position and angular position of at least two of the image capturing devices or at least one image capturing device and the real object or scene may be tracked. This may have particular application where the real object is a human body and the data points are selected based on anatomical landmarks on the patient. The adjusting and verifying the correct relative positions and transformations may be an automatic or semi-automatic co-registration method based on the image information.

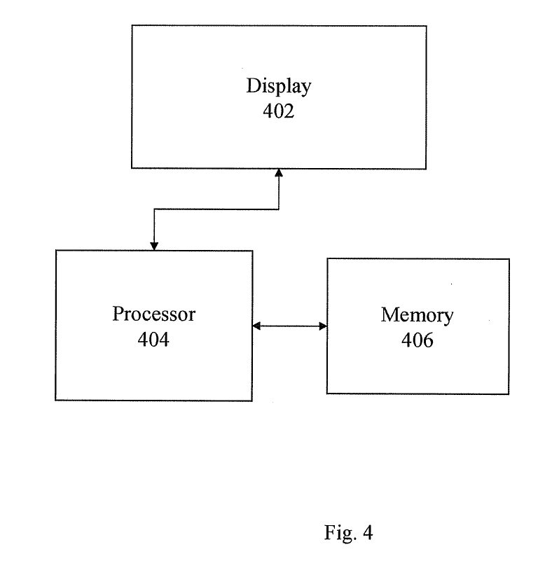

FIG. 4 is a block diagram of an autostereoscopic display apparatus or a light field display apparatus. The autostereoscopic display apparatus or a light field display apparatus comprises: a display 402; a processor 404; and a memory 406 having stored therein one or more routines executable by the processor, the one or more routines being adapted to operate according to one or more of the methods described herein.

A computer-readable medium may also be provided having computer-executable instructions adapted to cause a device to perform one or more of the methods described herein.

1.-17. (canceled)

18. An autostereoscopic display apparatus or a light field display apparatus arranged to provide different display properties to different viewer positions.

19. A display apparatus according to claim 18 wherein the display properties are selected from the following:
color bit depth;
brightness;
contrast ratio;
spatial resolution;
image depth quality;
perspective density;
refresh rate;
flicker rate; and
gamma curve.

20. A display apparatus according to claim 18 where the display properties for a viewing position can be changed during operation of the display.

21. A display apparatus according to claim 18 where the display properties for different viewer positions are set to match the image content being shown to the viewer position in question.

22. A method for presenting three dimensional information on an autostereoscopic or lightfield display comprising showing at least two different representations of the three dimensional information to at least two different viewer positions.

23. A method according to claim 22 where the different representations of the three dimensional information are the result of different recording methods for the same three dimensional information.

24. A method according to claim 22 where the three dimensional information relates to a three dimensional object or scene and the different representations are different image capture methods.

25. A method according to claim 24 where the image capture methods include at least one of the following:
computed tomography;
magnetic resonance imaging;
ultrasound;
optical camera;
positron emission tomography; and
x-ray.

26. A method according to claim 22 where at least two different representations are the result of different processing of the same original representation.

27. A method according to claim 22 where the representations provide perspectives that are matched to the viewer position where the representation is shown.

28. A method for capturing and visualizing a real three dimensional object or scene comprising using at least two different image capturing methods to capture the real three dimensional object or scene, visualizing the captured information on an autostereoscopic or lightfield display, using data points from each image capturing method to verify and adjust the correct relative positions and transformations of the images captured using the different capturing methods.

29. A method according to claim 28 also comprising tracking the relative position and angular position of at least two of the image capturing devices or at least one image capturing device and the real object or scene.

30. A method according to claim 28 where the real object is a human body and the data points are selected based on anatomical landmarks on the patient.

31. A method according to claim 28 where the method to adjust and verify the correct relative positions and transformations is an automatic or semi-automatic co-registration method based on the image information.

32. An autostereoscopic display apparatus or a light field display apparatus comprising:
a processor; and
a memory having stored therein one or more routines executable by the processor, the one or more routines being adapted to operate according to the method of claim 22.

33. A computer-readable medium having computer-executable instructions adapted to cause a device to perform the method of claim 22.

34. A data carrier carrying thereon or therein data indicative of instructions executable by processing means to cause those means to carry out a method according to claim 22.
